(19) United States
(12) Patent Application Publication
(10) Pub. No.: US 2025/0327707 A1
(43) Pub. Date: Oct. 23, 2025

(54) WIRELESS FOOD TEMPERATURE DETECTOR FOR OVEN

(71) Applicant: Shenzhen Kemin Sensor Co., Ltd., Shenzhen (CN)

(72) Inventors: Qiang Zeng, Shenzhen (CN); Xiang Li, Shenzhen (CN); Jianguo Wu, Shenzhen (CN)

(21) Appl. No.: 18/742,446

(22) Filed: Jun. 13, 2024

(30) Foreign Application Priority Data
Apr. 18, 2024 (CN) 202410472530.X

(51) Int. Cl. G01K 1/024; G01K 1/08; G01K 7/24

(52) U.S. Cl. CPC G01K 1/024; G01K 1/08; G01K 7/24; G01K 2207/06

(57) ABSTRACT

A wireless food temperature detector for an oven includes a temperature probe. The temperature probe includes a needle, a probe tube and a Bluetooth signal transmission module. The needle is configured for extending into food, a first thermistor is arranged in the needle, one end of the probe tube is connected to the needle, and the Bluetooth signal transmission module is located in a cavity formed by the needle and the probe tube. The first thermistor is electrically connected to the Bluetooth signal transmission module, and the Bluetooth signal transmission module is configured to transmit a temperature signal detected by the first thermistor to the oven, a smart phone and a mobile control terminal.

### CROSS-REFERENCE TO RELATED APPLICATION

This patent application claims the benefit and priority of Chinese Patent Application No. 202410472530.X filed with the China National Intellectual Property Administration on Apr. 18 2024, the disclosure of which is incorporated by reference herein in its entirety as part of the present application.

### TECHNICAL FIELD

The present disclosure relates to the technical field of intelligent kitchen appliances, and in particular to a wireless food temperature detector for an oven.

### BACKGROUND

A food temperature probe can help people to achieve a consistent cooking effect every time when cooking food (meat). Traditionally, food cooking is done by chefs remembering the cooking temperature and time, and the appearance of the wireless food temperature detector makes it more convenient to display the temperature of food during cooking. However, such wireless temperature detectors usually only provide temperature display.

### SUMMARY

An objective of the present disclosure is to provide a wireless food temperature detector for an oven, so as to solve the problems in the prior art. The temperature signal can be transmitted to an oven, a smart phone and a mobile control terminal through a Bluetooth signal transmission module, making the temperature and time for cooking the food visually observed more accurately, and achieving a consistent cooking effect.

To achieve the objective above, the present disclosure provides the following technical solution:
A wireless food temperature detector for an oven is provided by the present disclosure, including a temperature probe. The temperature probe includes a needle, a probe tube, and a Bluetooth signal transmission module. The needle is used for extending into food, a first thermistor is arranged in the needle, one end of the probe tube is connected to the needle, and the Bluetooth signal transmission module is located in a cavity formed by the needle and the probe tube. The first thermistor is electrically connected to the Bluetooth signal transmission module, and the Bluetooth signal transmission module is configured to transmit a temperature signal detected by the first thermistor to the oven, a smart phone and a mobile control terminal.

Preferably, the Bluetooth signal transmission module includes a PCBA (Printed Circuit Board Assembly) circuit board, a Bluetooth chip, and a probe on/off switch. The first thermistor, the Bluetooth chip and the probe on/off switch each are electrically connected to the PCBA circuit board, respectively.

Preferably, the wireless food temperature detector further includes an antenna. The antenna is located in the cavity and in the shape of a spring, and one end of the antenna is connected to the PCBA circuit board.

Preferably, a battery is arranged in the cavity, and is connected to the PCBA circuit board via both a positive electrode lead for battery and a negative electrode lead for battery.

The needle is made of stainless steel, and is connected to the PCBA circuit board through a positive electrode lead.

The wireless food temperature detector further includes a negative electrode structure, wherein the negative electrode is made of stainless steel, and is connected to the PCBA through a negative electrode lead.

The wireless food temperature detector further comprises a negative electrode structure. The negative electrode structure is made of stainless steel, and is connected to the PCBA circuit board through a negative electrode lead.

Preferably, the probe tube is provided with a warning mark, and the Bluetooth signal transmission module is located between the needle and the warning mark.

The wireless food temperature detector further includes a second thermistor. The second thermistor is located on the Bluetooth signal transmission module and is electrically connected to the Bluetooth signal transmission module.

Preferably, the probe tube includes a first connecting tube, a second connecting tube and a handle connected in sequence. The first connecting tube and the handle are both made of ceramic, the second connecting tube is the negative electrode structure, and the other end of the antenna is abutted against the handle.

Preferably, the wireless food temperature detector further includes a third thermistor. The third thermistor is electrically connected to the Bluetooth signal transmission module.

The probe tube includes a probe tube body, and a tube cap. The probe tube body is made of ceramic, and the tube cap is made of stainless steel. One end of the probe tube body is connected to the needle, the tube cap is arranged at the other end of the probe tube body, and the third thermistor is located between the other end of the antenna and the tube cap.

Preferably, the negative electrode structure is a thimble, which is made of stainless steel and connected to the PCBA circuit board.

Preferably, the negative electrode structure is a protection tube, which is made of stainless steel and located in the probe tube. A side wall of the probe tube is provided with a negative electrode charging slot corresponding to the protection tube, and the protection tube is connected to the PCBA circuit board.

Preferably, the wireless food temperature detector further includes a charging case. The charging case includes an upper cover and a lower cover which are able to be detachably connected to each other. The upper cover and the lower cover form a placement groove for placing the temperature probe. A charging PCBA circuit board is placed in the charging case, and the charging PCBA circuit board is electrically connected to a first charging contact and a second charging contact at the placement groove; and a switch control structure is further arranged at the placement groove.

Compared with the prior art, the present embodiment has the following technical effects:

In this embodiment, electronic components such as a Bluetooth chip and a battery can be operates normally in a high-temperature environment, and a temperature signal can be transmitted to a smart phone, a mobile control terminal, a built-in receiver of an oven and an external reader to display the temperature, and the temperature of food can be identified through the received signals, thus intelligently adjusting the temperature and baking time of the oven.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a cross-sectional view of a temperature probe of a wireless food temperature detector for an oven according to the present disclosure (Embodiment 1);

FIG. 2 is an axonometric perspective diagram of a temperature probe according to the present disclosure (Embodiment 1);

FIG. 3 is a first schematic diagram of a charging case according to the present disclosure;

FIG. 4 is a second schematic diagram of a charging case according to the present disclosure;

FIG. 5 is a schematic diagram of application of a wireless food temperature detector for an oven according to the present disclosure;

FIG. 6 is a cross-sectional view of a temperature probe of a wireless food temperature detector for an oven according to the present disclosure (Embodiment 2);

FIG. 7 is a schematic diagram of a warning mark according to the present disclosure (Embodiment 2);

FIG. 8 is an axonometric perspective diagram of a temperature probe according to the present disclosure (Embodiment 2);

FIG. 9 is a cross-sectional view of a temperature probe of a wireless food temperature detector for an oven according to the present disclosure (Embodiment 3);

FIG. 10 is a schematic diagram of a warning mark according to the present disclosure (Embodiment 3);

FIG. 11 is an axonometric perspective diagram of a temperature probe according to the present disclosure (Embodiment 3).

In the drawings: 1—first thermistor; 2—first thermistor lead; 3—needle; 4—first connecting tube; 5—battery; 6—positive electrode lead for battery; 7—positive electrode lead; 8—negative electrode lead for battery; 9—negative electrode lead; 10—second connecting tube; 11—Bluetooth chip; 12—second thermistor; 13—probe on/off switch; 14—PCBA circuit board; 15—warning mark; 16—antenna; 17—handle; 18—upper cover; 19—placement groove; 20—second charging lead; 21—second charging contact; 22—first charging lead; 23—first charging contact; 24—lower cover; 25—detector charging indicator; 26—charging PCBA circuit board; 27—USB charging plug; 28—detector power indicator; 29—switch control structure; 30—threaded hole; 31—oven; 32—food; 33—mobile control terminal; 34—smart phone; 35—thimble; 36—probe tube body; 37—third thermistor; 38—sealing ring; 39—tube cap; 40—third thermistor lead; 41—protection tube; 42—negative electrode charging slot.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a wireless food temperature detector for an oven, so as to solve the problems in the prior art. The temperature signal can be transmitted to an oven, a smart phone and a mobile control terminal through a Bluetooth signal transmission module, making the temperature and time for cooking the food visually observed more accurately, and achieving a consistent cooking effect.

In order to make the objectives, features and advantages of the present disclosure more clearly, the present disclosure is further described in detail below with reference to the embodiments.

### Embodiment 1

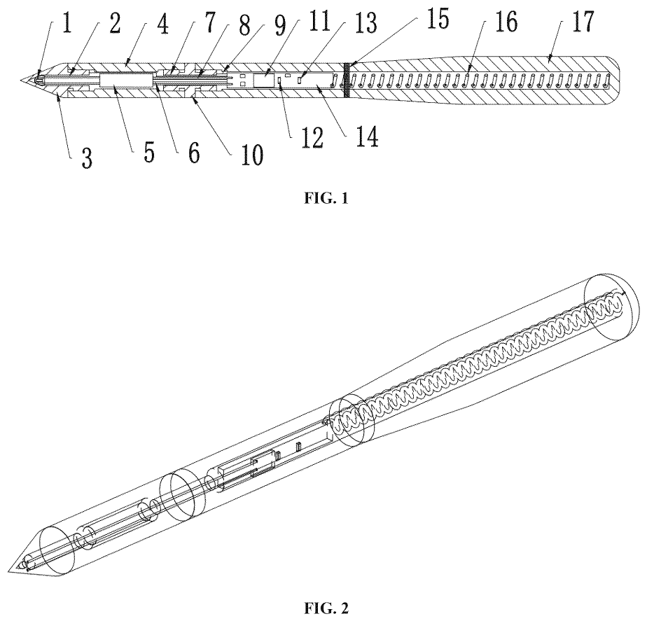

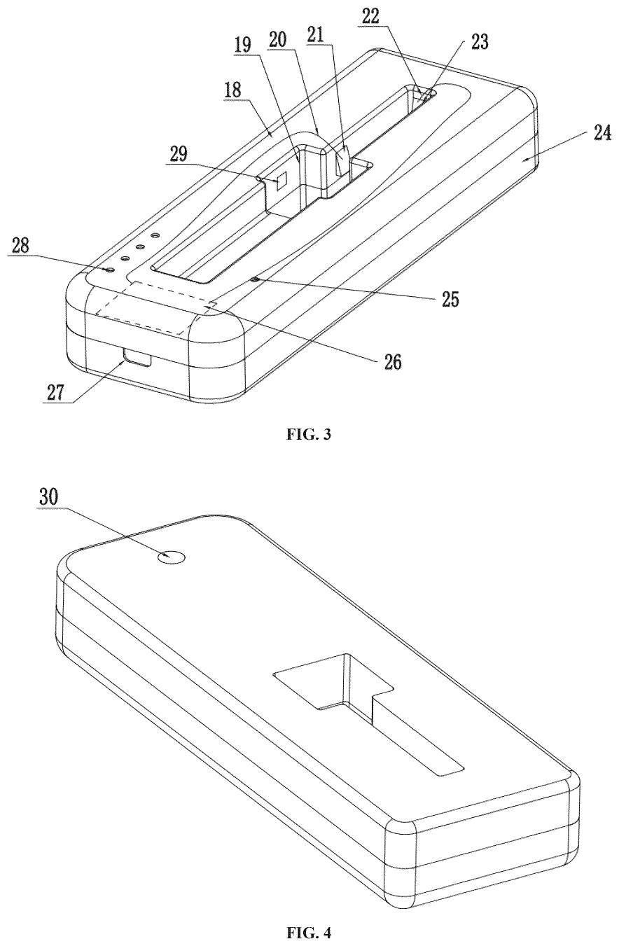

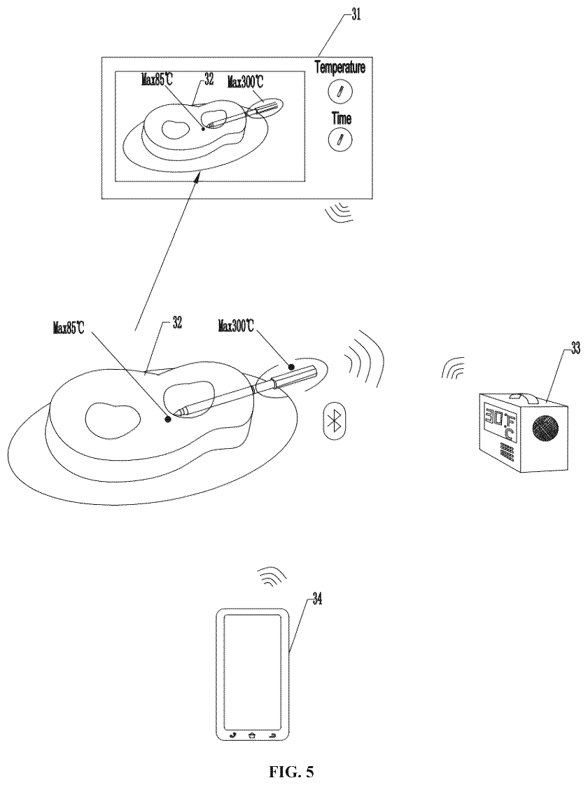

As shown in FIGS. 1 to 5, a wireless food temperature detector for an oven provided by this embodiment includes a temperature probe and a charging case. The temperature probe includes a needle 3, a probe tube, and a Bluetooth signal transmission module. The needle 3 is configured for extending into food 32, and a first thermistor 1 is arranged in the needle 3. The first thermistor 1 is a patch thermistor, and is attached to one side, close to a needle tip, of the needle 3 to detect an internal temperature of the food 32 more accurately, and thus the response time is greatly shortened. One end of the probe tube is connected to the needle 3, the probe tube is in the shape of a long tube, meets the food-grade requirements, and is not limited in color and pattern. The Bluetooth signal transmission module is located in a cavity formed by the needle 3 and the probe tube. The first thermistor 1 is electrically connected to a PCBA circuit board 14 of the Bluetooth signal transmission module via a first thermistor lead 2. The Bluetooth signal transmission module is configured to transmit a temperature signal detected by the first thermistor 1 to an oven 31, a smart phone 34 and a mobile control terminal 33.

Specifically, in this embodiment, the Bluetooth signal transmission module includes a PCBA circuit board 14, a second thermistor 12, a Bluetooth chip 11, and a probe on/off switch 13. The PCBA circuit board 14 is provided with an IC (integrated circuit) processor. The Bluetooth chip 11, the second thermistor 12 and the probe on/off switch 13 are integrated on the PCBA circuit board 14 in a welding manner. The second thermistor 12 plays a role of high-temperature warning for electronic components on the PCBA circuit board 14, so as to prevent the electronic components from being damaged due to high temperature when the user does not insert the wireless detector in place. The first thermistor 1, the Bluetooth chip 11, the second thermistor 12 and the probe on/off switch 13 are electrically connected to the PCBA circuit board 14.

In this embodiment, a battery 5 is arranged in the cavity, and is located between the needle 3 and the PCBA circuit board 14. The battery 5 is connected to the PCBA circuit board 14 via both a positive electrode lead for battery 6 and a negative electrode lead for battery 8. The needle 3 is made of stainless steel, preferably SUS304 or SUS316 stainless steel. The needle 3 is connected to the PCBA circuit board 14 via a positive electrode lead 7, and the needle 3 serves as a charging positive electrode of the battery 5.

In this embodiment, the wireless food temperature detector further includes a negative electrode structure serving as a charging negative electrode of the battery 5. The negative electrode is made of stainless steel, and is connected to the PCBA circuit board 14 via a negative electrode lead 9.

In this embodiment, the probe tube and the needle 3 are used to protect internal elements. The probe tube includes a first connecting tube 4, a second connecting tube 10 and a handle 17 connected in sequence. The second connecting tube 10 is threadedly connected to the first connecting tube 4 and the handle 17, respectively, and is sealed by gluing to achieve excellent waterproof and oil resistance, and thus the wireless detector can be put into a dishwasher for cleaning as a whole. Alternatively, the second connecting tube 10 is in interference riveting with the first connecting tube 4 and the handle 17, respectively. The first connecting tube 4 and the handle 17 are both made of ceramic, preferably zirconia ceramics. The second connecting tube 10 is made of stainless steel, preferably SUS304 or SUS316 stainless steel. In this embodiment, the second connecting tube 10 is a negative electrode structure. In this embodiment, the handle 17 made of ceramic is exposed outside the food 32, and the needle 3, the first connecting tube 4 and the second connecting tube 10 are located inside the food 32. As sleeves made of different materials are used for thermal insulation, the influence that the ceramic handle 17 outside the food 32 is subjected to the high temperature in the cavity of the oven 31 on the temperature detection of the first thermistor 1 at the needle tip can be reduced, and the temperature detection accuracy of the first thermistor 1 at the needle tip can be indirectly improved.

In this embodiment, the wireless food temperature detector further includes an antenna 16. The antenna 16 is located in the cavity and in the shape of a spring. One end of the antenna 16 is welded to the PCBA circuit board 14, and the other end of the antenna 16 is abutted against the handle 17. The spring-shaped antenna 16 is configured for positioning the PCBA circuit board 14, and making the PCBA circuit board 14 tightly attached to the second connecting tube 10, thereby preventing the PCBA circuit board 14 from moving in the handle 17. Temperature signals detected by the first thermistor 1 and the second thermistor 12 are transmitted via the antenna 16 by the Bluetooth signal transmission module.

In this embodiment, the probe tube is provided with a warning mark 15, the warning mark 15 is printed on the handle 17 by screen printing, and the Bluetooth signal transmission module is located between the needle 3 and the warning mark 15. The warning mark 15 serves as a package position of each electronic component. A distance between the warning mark 15 and the PCBA circuit board 14 is about 10 mm. During use, the needle 3, the battery 5, the PCBA circuit board 14 and other electronic components should be completely inserted into the food 32, and the warning mark 15 should be completely submerged into the food 32 during the cooking of the food 32, so as to isolate the high temperature in the oven 31, and make the detector operate normally at a temperature of 0-300° C.

In this embodiment, the first thermistor 1 and the second thermistor 12 are negative temperature coefficient thermistors, or other thermo-sensitive elements. The first thermistor 1 and the second thermistor 12 may also be replaced with other digital temperature sensors.

In this embodiment, the charging case includes an upper cover 18 and a lower cover 24. The upper cover 18 and the lower cover 24 are made of plastic and can be detachably connected to each other by a bolt. Each of the upper cover 18 and the lower cover 24 is provided with a threaded hole 30 for the bolt to pass through, and the upper cover 18 and the lower cover 24 form a placement groove 19 for placing a temperature probe. The charging case is internally provided with a charging PCBA circuit board 26. The charging PCBA circuit board 26 is electrically connected to a first charging contact 23 at the placement groove 19 via a first charging lead 22, and the charging PCBA circuit board 26 is electrically connected to a second charging contact 21 at the placement groove 29 via a second charging lead 20. The first charging contact 23 is configured for making contact with the needle 3, and the second charging contact 21 is configured for making contact with the negative electrode structure. The placement groove 19 is further provided with a switch control structure 29, which is configured to match with the probe on/off switch 13 and control the on/off of the wireless detector. The probe on/off switch 13 is preferably a magnetic induction switch, and the switch control structure 29 is preferably a magnet.

In this embodiment, the probe on/off switch 13 may also be other switch elements or physical structural switches.

In this embodiment, the charging PCBA circuit board 26 may also be provided with a USB charging plug 27, a detector charging indicator 25, and a detector power indicator 28. A charging state of the detector can be known through the detector charging indicator 25, and the electrical quantity of the detector can be known through the detector power indicator 28.

In this embodiment, the positive electrode lead for battery 6, the negative electrode lead for battery 8, a positive electrode lead 7, a negative electrode lead 9, the first charging lead 22 and the second charging lead 20 are all Dumet wires or electronic high-temperature wires, and the colors are not limited.

In this embodiment, the battery 5 is a lithium battery, a thin-film lithium battery, a super capacitor, or an energy storage battery.

A use method of this embodiment is as follows: a tip end of the probe tube is inserted into meat food 32, the warning mark 15 is located in the food 32 (an internal temperature of the food 32 cannot exceed 85° C.), and high temperature is isolated by the food 32, such that the electronic components in the probe tube cannot be damaged when the temperature outside the food 32 is 230° C.-300° C., and the wireless detector can operate normally. The temperature signal of the food 32 is transmitted by the first thermistor 1 to the IC processor on the PCBA circuit board 14, and then is transmitted by the Bluetooth chip 11 and the antenna 16 in the handle 17 to the Bluetooth receiver arranged in the oven 31, the smart phone 34 and the mobile control terminal 33, making the temperature and time for cooking the food 32 visually observed more accurately, and achieving a consistent cooking effect.

In this embodiment, electronic components such as the Bluetooth chip 11 and the battery 5 can operate normally in a high-temperature environment, and the temperature signal can be transmitted to a smart phone, a mobile control terminal, a built-in receiver of an oven 31 and an external reader to display the temperature, and the temperature of the food 32 can be identified through the received signals, thus intelligently adjusting the temperature and baking time of the oven 31.

### Embodiment 2

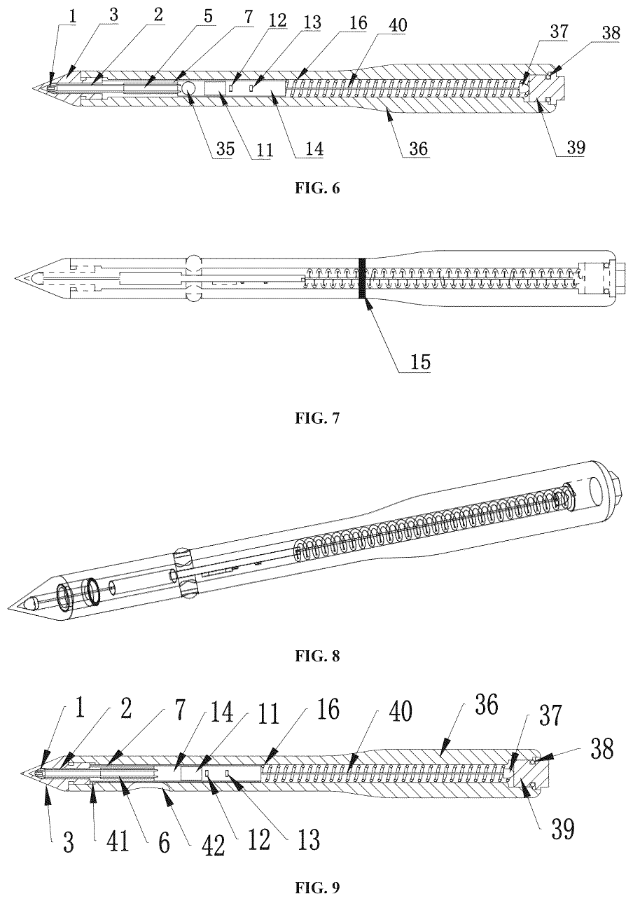

As shown in FIGS. 6 to 8, the difference of this embodiment from Embodiment 1 is that: this embodiment further includes a third thermistor 37, the third thermistor 37 is electrically connected to the PCBA circuit board 14 of the Bluetooth signal transmission module via a third thermistor lead 40, and the third thermistor 37 can detect a temperature on the surface of the food 32 and a temperature in the cavity of the oven 31.

The probe tube of this embodiment includes a probe tube body 36 and a tube cap 39. The probe tube body 36 is made of ceramic, preferably zirconia, and thus the probe tube body 36 can be used at 300° C. The tube cap 39 is a T-shaped nut, which is made of stainless steel, preferably SUS304 or SUS316 stainless steel. One end of the probe tube body 36 is threadedly connected to the needle 3 and sealed by gluing. The tube cap 39 is arranged at the other end of the probe tube body 36 and is threadedly connected to the other end of the probe tube body 36. A sealing ring 38 is arranged between the tube cap 39 and the probe tube body 36 to improve the tightness and waterproofness. The third thermistor 37 is located between the other end of the antenna 16 and the tube cap 39, and the other end of the antenna 16 is bonded with the third thermistor 37. The third thermistor 37 is pressed against the tube cap 39 by the antenna 16, and thus the third thermistor 37 can accurately detect the temperature of the surface of the food 32 and the cavity in the oven 31.

The probe tube body 36 for protecting the electronic components is made of a ceramic material, while the needle 3 and the tube cap 39 are all made of food-grade SUS304 or SUS316 stainless steel, so as improve the detection sensitivity and temperature detection accuracy of the first thermistor 1, the second thermistor 12 and the third thermistor 37.

In this embodiment, the negative electrode structure is a thimble 35, the thimble 35 is made of stainless steel, and is connected to the PCBA circuit board 14. When the temperature probe is located in the charging case, the thimble 35 is in contact with the second charging contact 21.

A use method of this embodiment is as follows: a tip end of the probe tube is inserted into meat food 32, the warning mark 15 is located in the food 32, and high temperature is isolated by the food 32, such that the electronic components in the probe tube cannot be damaged when the temperature outside the food 32 is 230° C.-300° C., and the wireless detector can operate normally. The temperature signal of the food 32 is transmitted by the first thermistor 1 to the IC processor on the PCBA circuit board 14, and then is transmitted by the Bluetooth chip 11 and the antenna 16 in the probe tube body 36 to the Bluetooth receiver arranged in the oven 31, the smart phone 34 and the mobile control terminal 33, making the temperature and time for cooking the food 32 visually observed more accurately, and achieving a consistent cooking effect.

### Embodiment 3

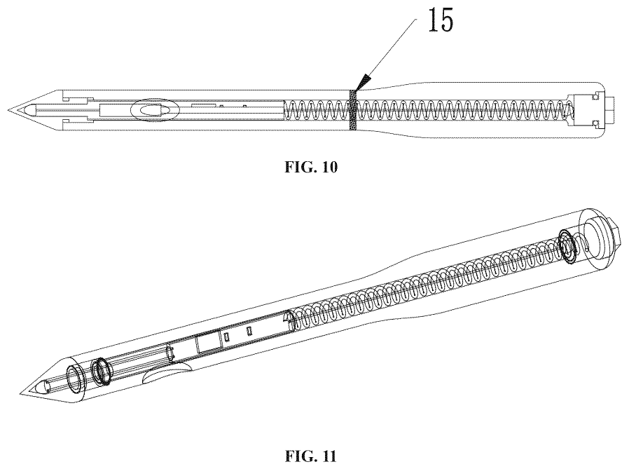

As shown in FIG. 9 to FIG. 11, the difference of this embodiment from Embodiment 2 is that: in this embodiment, the negative electrode structure is a protection tube 41, the protection tube 41 is made of stainless steel, and is located in the probe tube. A side wall of the probe tube is provided with a negative electrode charging slot 42 corresponding to the protection tube 41, and the protection tube 41 is connected to the PCBA circuit board 14. When the temperature probe is located in the charging case, the protection tube 41 is in contact with the second charging contact 21.

A use method of this embodiment is as follows: a tip end of the probe tube is inserted into meat food 32, the warning mark 15 is located in the food 32, and high temperature is isolated by the food 32, such that the electronic components in the probe tube cannot be damaged when the temperature outside the food 32 is 230° C.-300° C., and the wireless detector can operate normally. The temperature signal of the food 32 is transmitted by the first thermistor 1 to the IC processor on the PCBA circuit board 14, and then is transmitted by the Bluetooth chip 11 and the antenna 16 in the probe tube body 36 to the Bluetooth receiver arranged in the oven 31, the smart phone 34 and the mobile control terminal 33, making the temperature and time for cooking the food 32 visually observed more accurately, and achieving a consistent cooking effect.

Specific examples are used herein for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A wireless food temperature detector for an oven, comprising: a temperature probe, wherein the temperature probe comprises a needle, a probe tube, and a Bluetooth signal transmission module; the needle is configured for extending into food, a first thermistor is arranged in the needle, one end of the probe tube is connected to the needle, and the Bluetooth signal transmission module is located in a cavity formed by the needle and the probe tube; the first thermistor is electrically connected to the Bluetooth signal transmission module, and the Bluetooth signal transmission module is configured to transmit a temperature signal detected by the first thermistor to the oven, a smart phone and a mobile control terminal.

2. The wireless food temperature detector for an oven according to claim 1, wherein the Bluetooth signal transmission module comprises a PCBA (Printed Circuit Board Assembly) circuit board, a Bluetooth chip, and a probe on/off switch; and the first thermistor, the Bluetooth chip and the probe on/off switch each are electrically connected to the PCBA circuit board.

3. The wireless food temperature detector for an oven according to claim 2, further comprising an antenna, wherein the antenna is located in the cavity and in a shape of a spring, and one end of the antenna is connected to the PCBA circuit board.

4. The wireless food temperature detector for an oven according to claim 3, wherein a battery is arranged in the cavity, and is connected to the PCBA circuit board via both a positive electrode lead for battery and a negative electrode lead for battery;
the needle is made of stainless steel, and is connected to the PCBA circuit board via a positive electrode lead; and
the wireless food temperature detector further comprises a negative electrode structure, wherein the negative electrode structure is made of stainless steel, and is connected to the PCBA circuit board via a negative electrode lead.

5. The wireless food temperature detector for an oven according to claim 1, wherein the probe tube is provided with a warning mark, and the Bluetooth signal transmission module is located between the needle and the warning mark; and
the wireless food temperature detector further comprises a second thermistor; and the second thermistor is located on and electrically connected to the Bluetooth signal transmission module.

6. The wireless food temperature detector for an oven according to claim 4, wherein the probe tube comprises a first connecting tube, a second connecting tube and a handle connected in sequence; the first connecting tube and the handle are both made of ceramic, the second connecting tube is the negative electrode structure, and an other end of the antenna is abutted against the handle.

7. The wireless food temperature detector for an oven according to claim 4, further comprising a third thermistor electrically connected to the Bluetooth signal transmission module; and
the probe tube comprises a probe tube body and a tube cap; the probe tube body is made of ceramic, and the tube cap is made of stainless steel; one end of the probe tube body is connected to the needle, the tube cap is arranged at an other end of the probe tube body, and the third thermistor is located between the other end of the antenna and the tube cap.

8. The wireless food temperature detector for an oven according to claim 7, wherein the negative electrode structure is a thimble made of stainless steel and connected to the PCBA circuit board.

9. The wireless food temperature detector for an oven according to claim 7, wherein the negative electrode structure is a protection tube made of stainless steel and located in the probe tube; and a side wall of the probe tube is provided with a negative electrode charging slot corresponding to the protection tube, and the protection tube is connected to the PCBA circuit board.

10. The wireless food temperature detector for an oven according to claim 1, further comprising a charging case, wherein the charging case comprises an upper cover and a lower cover which are able to be detachably connected to each other; the upper cover and the lower cover form a placement groove for placing the temperature probe; a charging PCBA circuit board is placed in the charging case, and the charging PCBA circuit board is electrically connected to a first charging contact and a second charging contact at the placement groove, and a switch control structure is further arranged at the placement groove.
